(19) United States
(12) Patent Application Publication
(10) Pub. No.: US 2021/0362252 A1
(43) Pub. Date: Nov. 25, 2021

(54) PORTABLE CIRCULAR SAW FOR CUTTING METAL

(71) Applicant: MAKITA CORPORATION, Anjo-shi, Aichi (JP)

(72) Inventors: Takuji KIMURA, Anjo-shi (JP); Kenji NOSE, Anjo-shi (JP); Tomoki TAKATA, Anjo-shi (JP)

(73) Assignee: Makita Corporation, Anjo-shi, Aichi (JP)

(21) Appl. No.: 17/052,938

(22) PCT Filed: May 8, 2019
(86) PCT No.: PCT/JP2019/018376

§ 371 Date: Nov. 4, 2020

(30) Foreign Application Priority Data
May 15, 2018 (JP) 2018-093897

(51) Int. Cl. B23D 45/16

(52) U.S. Cl. CPC B23D 45/16

(57) ABSTRACT

A portable circular saw for cutting metal, a dust collection efficiency of cutting dust blown up from a cutting position into a cutting dust collection box is improved. A distance between in inner wall surface of a fixing cover and a tooth tip of a circular saw blade is set to longer than a distance between the tooth tip and a tooth bottom and also longer than twice as long as the distance. Furthermore, a distance between a front end of a window in a base and the tooth tip of the circular saw blade is set longer than the distance between the tooth tip and a tooth bottom and shorter than twice the distance.

### CROSS-REFERENCE TO RELATED APPLICATIONS

The present application is a U.S. National Phase entry of, and claims propriety to, PCT Application No. PCT/JP2019/018376, filed May 8, 2019, which claims priority to Japanese Patent Application No. 2018-093897, filed May 15, 2018, both of which are incorporated herein by reference in their entireties for all purposes.

### BACKGROUND

The present disclosure relates to a portable circular saw for cutting metal by holding and moving the portable circular saw by hand.

For example, in a portable circular saw (portable cutting device) for cutting metal, which is referred to as a tip saw cutter in which a chip saw is used for cutting metal, various countermeasures are taken. For example, countermeasures are taken for effectively catching sparks that are generated when cutting work is performed and also catching cutting dust produced while the sparks are solidified. A dust collection structure related to these kind of circular saws is disclosed in the following Patent Document 1 and Patent Document 2.

Patent Document 1 (Japanese Laid-Open Patent Publication No. 2005-138220) discloses a technique in which cutting dust generated at a cutting position is blown up with a flow generated by rotation of a circular saw blade (chip saw), such that cutting dust is collected in a cutting dust collection box. Patent Document 2 (Japanese Laid-Open Patent Publication No. 2012-030356) discloses a technique in which an inner wall of a fixing cover, which covers a periphery of a circular saw blade, is curved. This allows the cutting dust to be blown out to the curved inner wall so as to control a scattering direction of cutting dust, thereby improving the efficiency for collecting cutting dust in the cutting dust collection box. A tip saw is a kind of circular saw blade that is obtained by integrally welding a tip to a base metal, both of which are manufactured as separate members.

### SUMMARY

However, according to the prior art disclosed in the former Patent Document 1, because a front of the fixing cover is too large, the effect of the rotating flow to blow up the generated cutting dust is not sufficiently exhibited. Thus, cutting dust may not be efficiently flown deep into the cutting dust collection box. In this respect, collection efficiency into the cutting dust collection box is not sufficient. Furthermore, according to the prior art disclosed in the latter Patent Document 2, a large leakage of the collected cutting dust occurs (a large quantity of cutting dust flows out of a dust collection opening) because an entrance of the cutting dust collection box (dust collection opening) is too small. In this respect, collection efficiency is not sufficient. There are specific features when cutting metal, cutting dust of metal is heavier than that of wood. Accordingly, the cutting dust of metal easily flows in a radial direction, owing to a stronger centrifugal force acted thereon. Additionally, fewer metal cuttings flow in the air, which is strongly influenced by rotation power of the circular saw blade. There is no prior art in which these features are fully analyzed and optimized.

The present disclosure aims to further improve collection efficiency of the cutting dust generated by the portable circular saw for cutting metal.

The above described problems can be solved by using at least the following aspects. A first aspect is a portable circular saw for cutting metal that comprises a base having a lower surface which contacts a cutting material and a cutting device main body supported on an upper surface of the base. Also, the cutting device main body comprises a circular saw blade, a fixing cover that covers the circular saw blade, and a cutting dust collection box that collects cutting dust generated when metal is cut. Cutting is performed by protruding the circular saw blade from the lower surface of the base via a window provided in the base. A protruding portion of the circular saw blade cuts into the cutting material. In the first aspect, at a lower end of the fixing cover, a distance X1 between an inner wall surface of the fixing cover and a tooth tip of the circular saw blade is set longer than a distance T between the tooth tip and a tooth bottom of the circular saw blade and shorter than twice as long as such distance T. In this document, the circular saw blade includes both of a tip saw and a circular saw blade other than the tip saw. The tooth tip means an outermost end of the saw blade and the tooth bottom means an innermost end of the tooth of the saw blade. The tooth means a notch formed along an outer circumference of the circular saw blade. In a case of the chip saw, the tooth is formed by a tip and a portion of the base metal.

According to the first aspect, at the lower end of the fixing cover relating to a position in an up-to-down direction, the distance X1 between the inner wall surface of the fixing cover and the tooth tip is set longer than the distance T between the tooth tip and the tooth bottom and shorter than twice as long as such distance T (the distance T<the distance X1<the distance T×2). Because the distance X1 is set longer than the distance T, when the metal cutting dust that has accumulated in the tooth bottom (cutting dust accumulated within a length of the distance T) is emitted outside in a radial direction of the circular saw blade, owing to a centrifugal force, the emitted cutting dust may be smoothly emitted to a gap (space) between the tooth tip and an inner wall of the fixing cover. It is emitted such that the cutting dust is not blocked by the inner wall surface of the fixing cover, which may improve dust collection efficiency. Also, because the distance X1 is set shorter than twice as long as the distance T, the device may avoid an effect that is caused by a phenomenon that a flow speed is rapidly reduced at a position exceeding twice as long as the distance T in the radial direction. Because of this, emitted cutting dust can efficiently be collected within the cutting dust collection box due to the rotational flow.

The second aspect, which relates to the portable circular saw according to the first aspect, is characterized in that a distance Y between a front end of the window in the base and the tooth tip of the circular saw blade is set longer than the distance T between the tooth tip and the tooth bottom and shorter than twice as long as this distance T.

According to the second aspect, cutting dust flowing to the tooth bottom may be emitted to a gap (the distance Y) between the tooth tip and the front end of the window in the base and be collected within the fixing cover. Also, because the distance Y is set twice as long as the distance T, the rotational flow can fully act on the emitted cutting dust, so as to allow the emitted cutting dust to flow along the inner wall surface of the fixing cover in a reliable manner. In this respect, dust collection efficiency of the fixing cover can be further improved.

The third aspect, which relates to the portable circular saw according to the first aspect or the second aspect, is characterized in that a distance X2 between the inner wall surface of the fixing cover and the tooth tip of the circular saw blade at a height of a rotational center of the circular saw blade relating to a position in an up-to-down direction is set longer than the distance T and shorter than twice as long as this distance T.

According to the third aspect, at the height of the rotational center of the circular saw blade relating to the position in the up-to-down direction, the distance X2 between the inner wall surface of the fixing cover and the tooth tip of the circular saw blade may be set similar to the distance X1. Because of this configuration, cutting dust can be smoothly emitted into a gap (the distance X1) between the tooth tip and the inner wall surface, and the cutting dust can efficiently flow to the fixing cover due to the rotational flow.

The fourth aspect, which relates to the portable circular saw according to any one of the first aspect to the third aspect, is characterized in that the distance X1 is set longer than the distance Y between the front end of the window in the base and the tooth tip of the circular saw blade.

According to the fourth aspect, during a time when the tooth tip of the rotating circular saw blade enters into the fixing cover through the window in the base, cutting dust can be smoothly emitted from the tooth bottom, thereby improving dust collection efficiency.

The fifth aspect, which relates to the portable circular saw according to any one of the first aspect to the fourth aspect, is characterized in that a dust collection path into the cutting dust collection box is defined and arranged along and around the circular saw blade. A guide member is provided in a dust collection opening located at an inflow side end of the dust collection path in order to guide cutting dust to a side of the dust collection opening.

According to the fifth aspect, the guide member can improve dust collection efficiency into the dust collection opening.

The sixth aspect, which relates to the portable circular saw according to the fifth aspect, is characterized in that the guide member is arranged is a tilting manner, such that an outside of the guide member in a radial direction of the circular saw blade is displaced toward a front side in a rotational direction of the circular saw blade. The guide member has a fork shape extending on both sides, in a thickness direction, of the circular saw blade.

According to the sixth aspect, the guide member can further improve dust collection efficiency into the dust collection opening.

### BRIEF DESCRIPTION OF THE DRAWINGS

FIG. 1 is a right side view of a chip saw cutter according to an embodiment of the present disclosure.

FIG. 2 is a top view of the chip saw cutter according to the present embodiment, which is viewed in a direction indicated by arrow (II) in FIG. 1.

FIG. 3 is a front view of the chip saw cutter according to the present embodiment, which is viewed in a direction indicated by arrow (III) in FIG. 1.

FIG. 4 is a bottom view of the chip saw cutter according to the present embodiment, which is viewed in a direction indicated by arrow (IV) in FIG. 1.

FIG. 5 is a bottom view of the chip saw cutter according to the present embodiment. This figure shows a state in which a base is partially cut out and an area around a tooth tip is exposed.

FIG. 6 is a right side view of the chip saw cutter according to the present embodiment. This figure shows a state in which a fixing cover and a cutting dust collection box are partially cut out and an area around the tooth tip is exposed.

FIG. 7 is an enlarged view of an area around a cutting position, which is indicated by arrow (VII) in FIG. 6.

FIG. 8 is a cross-sectional view of the chip saw cutter, taken along line (VIII)-(VIII) of FIG. 6, which is viewed from a front side thereof.

FIG. 9 is a perspective view of the fixing cover and the cutting dust collection box.

FIG. 10 is a perspective view of the fixing cover separated from the cutting dust collection box.

### DETAILED DESCRIPTION

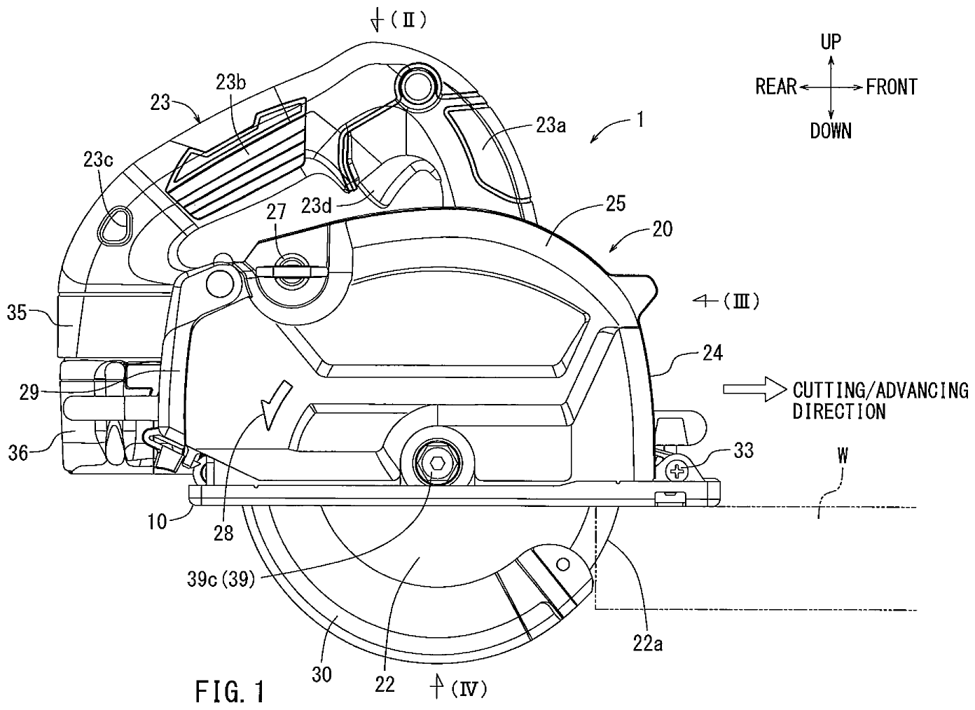

Next, embodiments according to the present aspect will be explained with reference to FIGS. 1 to 10. FIGS. 1 to 4 shows a chip saw cutter 1 according to the present embodiment. The tip saw cutter 1 is a cutting device for cutting metal, and comprises a base 10 configured to contact a cutting material W and a cutting device main body 20 that is supported on an upper surface side of the base 10. The base 10 has a rectangular plate form and a lower surface side of the base 10 contacts an upper surface of the cutting material W.

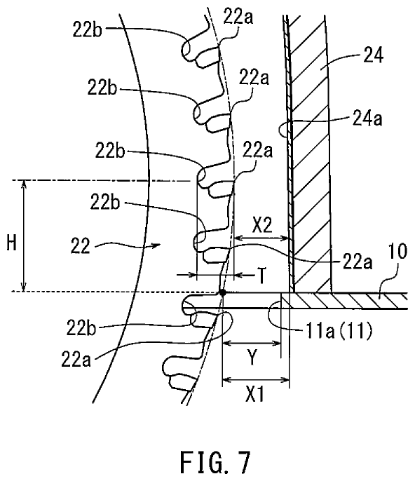

The cutting device main body 20 comprises an electric motor 21 as a drive source, a circular saw blade 22, and a loop-shaped handle 23. A brushless motor, which is high-powered and compact in a motor axis direction, is used as the electric motor 21. A tip saw blade for cutting steel material is used as the circular saw blade 22. As shown in FIG. 7, a semi-circular groove (tooth bottom 22b) for storing cutting dust is formed between adjacent tips of the circular saw blade 22 (between tooth tips 22a). There is set a distance T between the tooth tip 22a and the tooth bottom 22b.

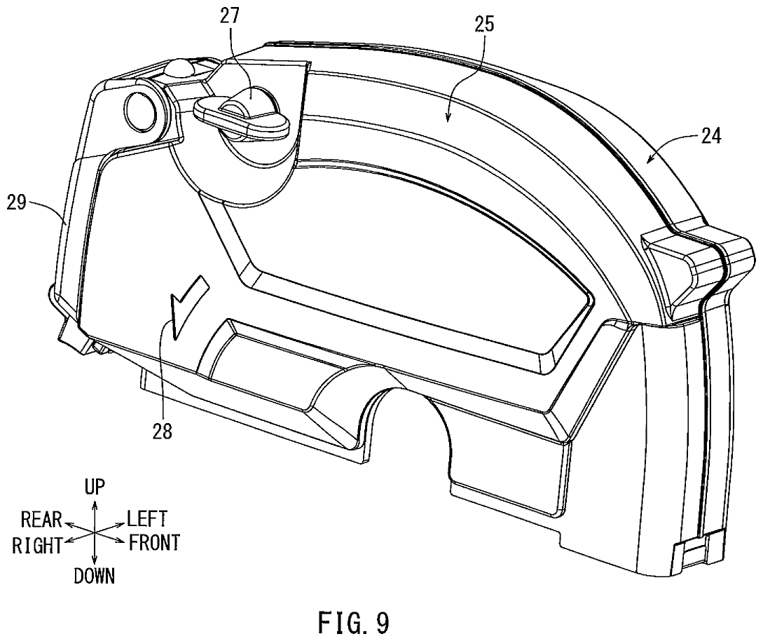

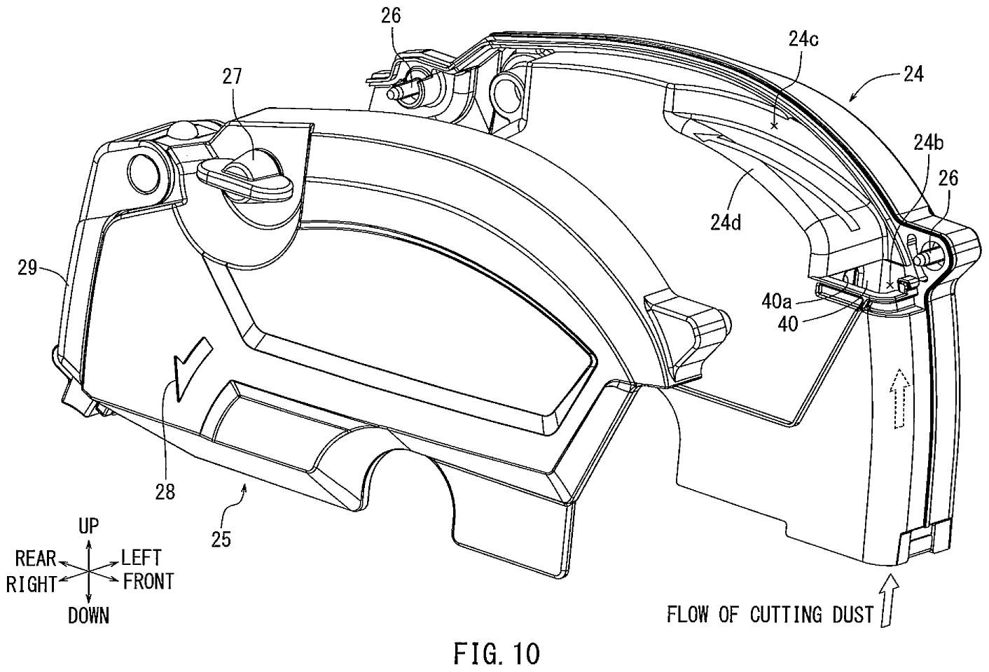

As shown in FIGS. 1 to 4, an area near an approximately upper semi-circular area of the circular saw blade 22 (on an upper surface side of the base 10) has a vessel-like shape and an area near a lower side thereof entirely opens. Also, the upper semi-circular area of the circular saw blade 22 is covered with a dust-proof fixing cover 24 that is designed to prevent scattering of cutting dust as much as possible. A cutting dust collection box 25 is arranged around the fixing cover 24 for collecting cutting dust generated at a position where the circular saw blade 22 cuts into the cutting material W (cutting position C). FIGS. 9 and 10 show some details of the fixing cover 24 and the cutting dust collection box 25. The fixing cover 24 and the cutting dust collection box 25 may each be formed using a transparent resin as a molding material, and may be held relative to each other by a plurality of fixing screws 26. The cutting dust collection box 25 is held on a right side of the fixing cover 24. Cutting dust blown up into the fixing cover 24 is collected into the cutting dust collection box 25 via a dust collection path 24c.

The fixing cover 24 is fixed to the cutting dust collection box 25 using a fixing screw 27 and is attached to the cutting device main body 20. The fixing cover 24 can be detached from around the circular saw blade 22 by loosening the fixing screw 27. An arrow 28 indicating a rotational direction of the circular saw blade 22 is marked on a right side surface of the cutting dust collection box 25. As shown in FIG. 1, the circular saw blade 22 rotates in a counterclockwise direction. Because of this, cutting dust at the cutting position C may be blown up with a counterclockwise rotational flow generated by rotation of the circular saw blade 22. A cover 29 for discharging the collected cutting dust is provided at a rear of the cutting dust collection box 25. A detail configuration of how cutting dust is collected into the cutting dust collection box 25 will be explained later.

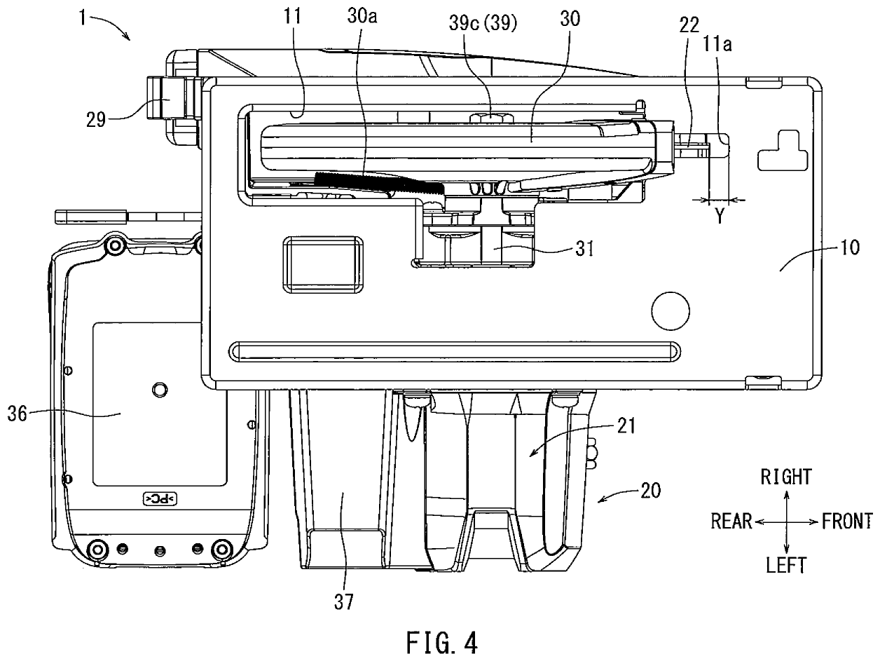

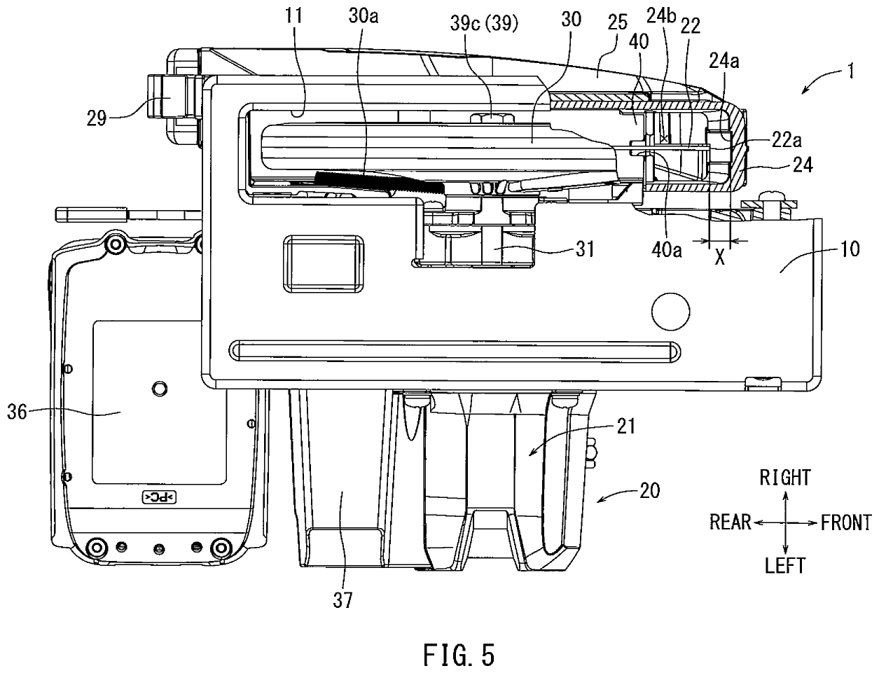

A lower portion side of the circular saw blade 22 protrudes from a lower surface side of the base 10 and through a long-groove-shaped window 11 formed in the base 10. Cutting is executed by this protruding portion cutting into the cutting material W. The tooth tips located at the lower portion side of the circular saw blade 22 that protrudes from the lower surface side of the base 10 are covered with a movable cover 30. The movable cover 30 is configured to rotate approximately around a rotational center of the circular saw blade 22, such that the tooth tips 22a can be exposed and covered. The movable cover 30 relatively opens in accordance with the movement of the tip saw cutter in a cutting/advancing direction while the movable cover 30 is in contact with the cutting material W. As shown in FIG. 4 and FIG. 5, a tension spring 30a is interposed between the movable cover 30 and the fixing cover 24. The movable cover 30 is spring-biased in a closing direction by the tension spring 30a.

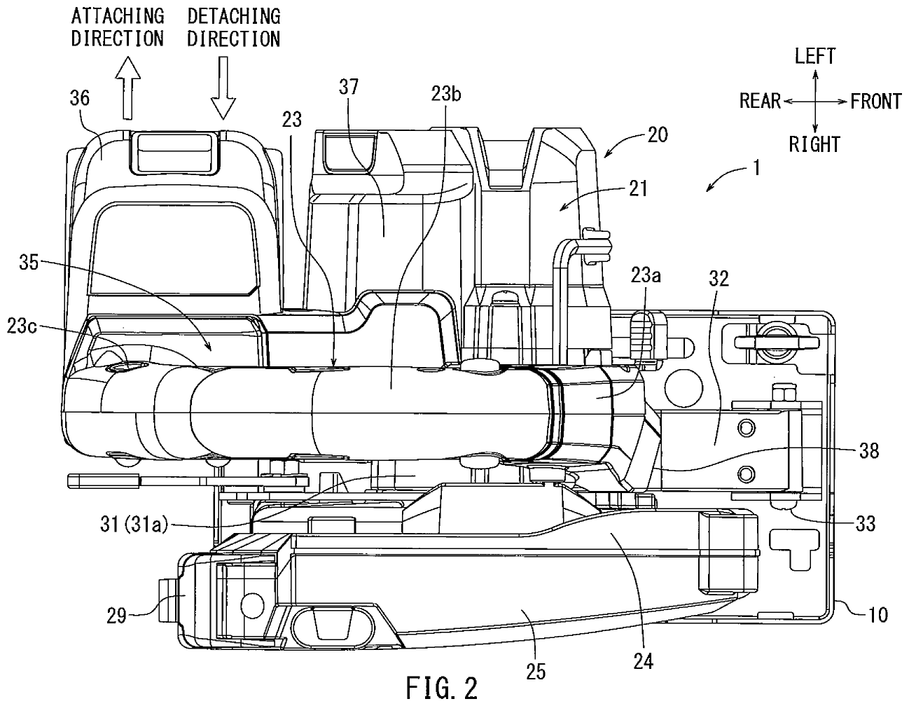

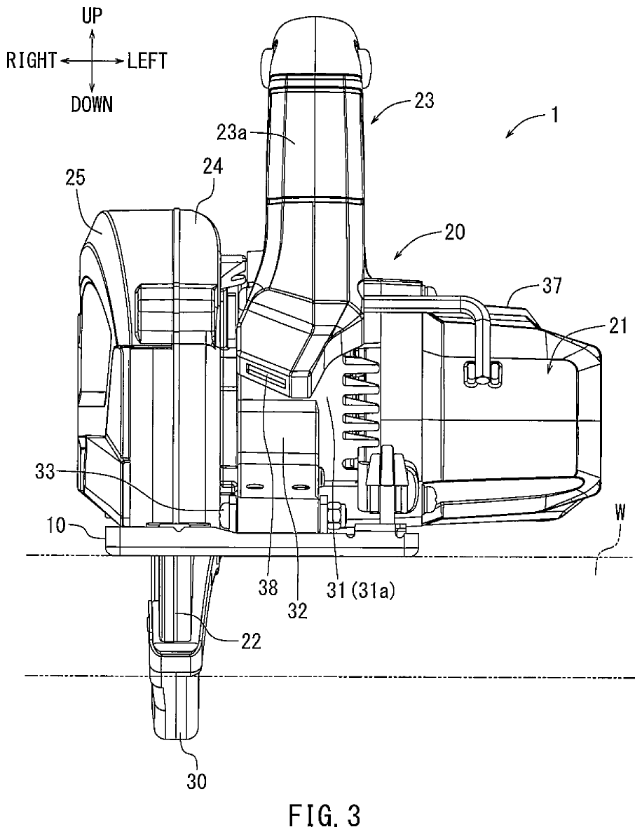

As shown in FIG. 2 and FIG. 3, the electric motor 21 is mounted on a left side of the fixing cover 24, with a speed reduction gear 31 positioned therebetween. A support arm 32 is formed integrally with a front portion of approximately a tubular-shaped gear housing 31a of the speed reduction gear 31. The support arm 32 extends in a frontward direction. A front of the support arm 32 is attached to an upper surface of the base 10 via an up-to-down swing shaft 33. The cutting device main body 20 is supported on the front upper surface of the base 10, so as to be swingable in an up-to-down direction via the up-to-down swing shaft 33. A protruding length of the circular saw blade 22 protruding downwards from the base 10 can be changed by swinging the cutting device main body 20 in the up-to-down direction with respect to the base 10. A cutting depth of the circular saw blade 22 with respect to the cutting material W can be adjusted by changing the protruding length of the circular saw blade 22 protruding from the base 10.

The loop-shaped handle 23 is formed above the speed reduction gear 31. A trigger-typed switch lever 23d is provided on an inner peripheral side of the handle 23. When the switch lever 23d is pulled upwards, for example, by a finger, a main switch (not shown in the figures) housed in the handle 23 is turned on. When the main switch is turned on, the electric motor 21 is activated. When the pulling operation of the switch lever 23d is released, the main switch is turned off and the electric motor 21 stops.

A front portion 23a of the handle 23 is connected to an upper portion of the gear housing 31a. The front portion 23a of the handle 23 rises upwards from the upper portion of the gear housing 31a. A grip 23b extends from an upper of the front portion 23a in an obliquely downward and rearward direction. A strap connection portion 23a for connecting a fall-prevention tether strap, etc. is formed in a rear portion of the grip 23b. A rear side portion of the grip 23b is connected to a rear surface side of the gear housing 31a via a battery attachment portion 35. A battery pack 36 is attached to a lower surface side of the battery attachment portion 35.

The electric motor 21 is powered by the battery pack 36 attached to the battery attachment portion 35. The battery pack 36 can be detached from the battery attachment portion 35 to allow for charging. Thus, the battery pack 36 can be repeatedly used. As shown by a void arrow in FIG. 2, the battery pack 36 can be attached to the battery attachment portion 35 by sliding the battery pack 36 in a rightward direction and detached from the battery attachment portion 35 by sliding it in a leftward direction.

A controller housing 37 is provided between the electric motor 21 and the battery attachment portion 35. The controller housing 37 houses a rectangular plate shaped controller in which a controller circuit board mainly for controlling the electric motor 21 is included.

An illumination device 38 is provided in front of the speed reduction gear 31 and at a lower of the front portion 23a of the handle 23. The cutting position C (cutting position of the circular saw blade 22 with respect to the cutting material W) can be brightly illuminated by the illumination device 38. Because of this, cutting work in a dark place, etc. can be conveniently executed.

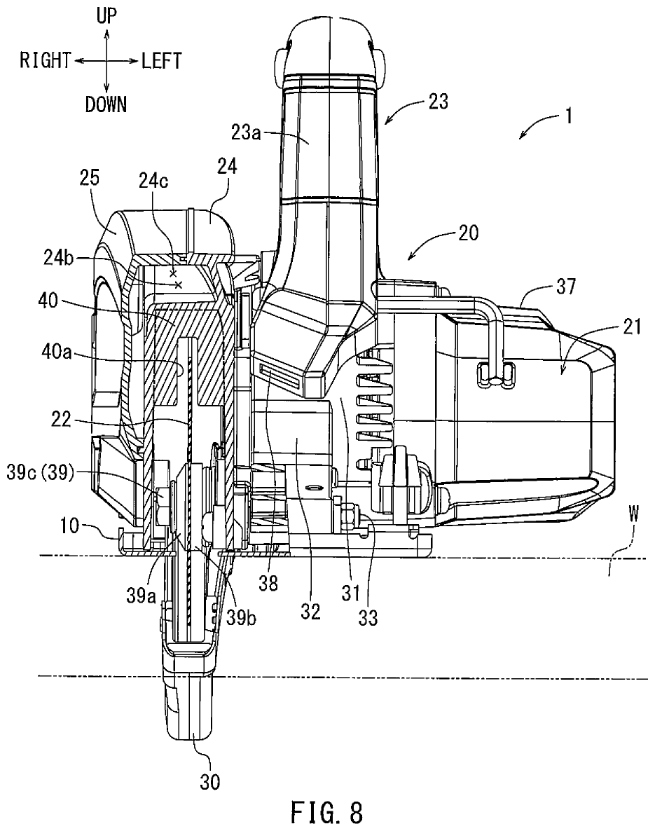

A rotation output of the electric motor 21 is transmitted to an output shaft 39 via the speed reduction gear 31. The output shaft 39 enters into an inner side of the fixing cover 24. The circular saw blade 22 is attached to a right end portion of the output shaft 39, the portion in the fixing cover 24. As shown in FIG. 8, the circular saw blade 22 is held between two attachment flanges 39a, 39b, and is attached to a right side of the output shaft 39 by fastening a fastening screw 39c.

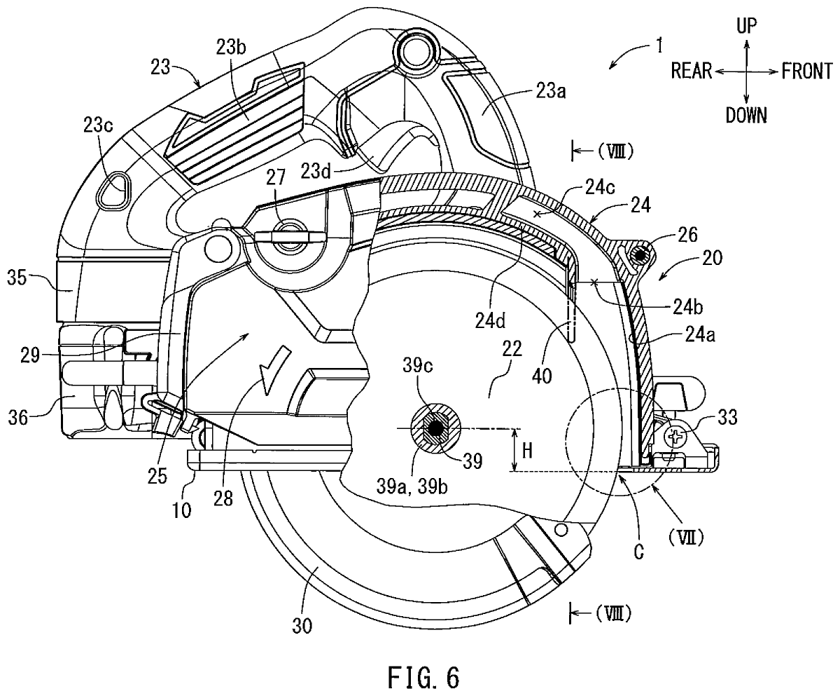

As shown in FIG. 6 and FIG. 7, as the tooth tip 22a of the circular saw blade 22 rotates in the counterclockwise direction, it passes through a front end 11a of the window 11 in the base 10 from a lower side to an upper side at the cutting position C. A counterclockwise rotational flow is generated by rotation of the circular saw blade 22. The rotational flow is blown upwards at the cutting position C. Cutting dust generated at the cutting position C is blown up into the fixing cover 24 by the rotational flow.

As shown in FIG. 7, in the present embodiment, there is a distance X1 between the tooth tip 22a of the circular saw blade 22 and an inner wall surface 24a of the fixing cover 24 at a lower end of the fixing cover 24, at a location relating to a position in an up-to-down direction. Also, there is a distance X2 between the tooth tip 22a of the circular saw blade 22 and the inner wall surface 24a of the fixing cover 24, the distance X2 being measured at a height H where a rotational center of the circular saw blade 22 is located, relative to a position in the up-to-down direction. In addition to the distance X1 and the distance X2, there is properly set a distance Y between the tooth tip 22a of the circular saw blade 22a and the front end 11a of the window 11, which improves dust collection efficiency. As described earlier, a semi-circular groove for temporarily storing cutting dust is formed between adjacent two tooth tips 22a of the circular saw blade 22. There is set a distance T between a bottom of the groove (tooth bottom 22b) and the tooth tip 22a.

In the present embodiment, the distance X1, the distance X2, and the distance Y are properly set with regard to the distance T. In the present embodiment, in a state where a cutting depth is set to the maximum, the distance X1 defined at the lower end of the fixing cover 24 is set to 1.8 times as long as the distance T, the distance from the tooth bottom 22b to the tooth tip 22a (X1=1.8T). Also, the distance X2, which is measured at the height H from the upper surface of the base 10 where the rotational center of the circular saw blade 22 is located (at the height where a distance X becomes the shortest and slightly above the cutting position C), is set to 1.7 times as long as the distance T, the distance from the tooth bottom 22b to the tooth tip 22a (X2=1.7T). Both the distance X1 and the distance X2 may be modified within a range longer than the distance T and shorter than twice as long as the distance T (the distance T<the distance X1, the distance X2<the distance T×2). It is not necessary that the distance X1 be precisely the same as the distance X2. The distance X1 may be different from the distance X2, as long as they are both set within the above described range. Also, the distance Y is set to 1.5 times as long as the distance T in this embodiment. However, the distance Y may be modified within a range that is longer than the distance T and shorter than twice as long as the distance T (the distance T<the distance Y<the distance T×2).

In this way, positions of the front end 11a of the window 11 and the inner wall surface 24a of the fixing cover 14 with regard to the tooth tip 22a are set to the distances X1, X2, and Y in a necessary and sufficient manner. Because of this configuration, cutting dust temporarily stored in the groove of the circular saw blade 22 may smoothly pass through the front end 11a of the window 11 and be emitted into the fixing cover 24.

Furthermore, the distance X1 and the distance Y are properly set such that the lower end of the fixing cover 24 does not cover the front end 11a of the window 11 in the base 10 (the distance X1>the distance Y). Because of this configuration, cutting dust passing through the front end 11a of the window 11 may be smoothly drawn into the fixing cover 24.

As shown in FIG. 6, a dust collection opening 24b is located within the fixing cover 24 and above the cutting position C. Also, a dust collection path 24c is formed rearwards from the dust collection opening 24b. The dust collection opening 24b and the dust collection path 24c serve as a lead opening and a lead passage, respectively, for the generated cutting dust flowing into the cutting dust collection box 25. A void arrow in FIG. 10 shows a flow of cutting dust (rotational flow). Cutting dust blown up from the cutting position C by the rotational flow generated by rotation of the circular blade saw 22 may flow from the dust collection opening 24b into the dust collection path 24c, along the inner wall surface of the fixing cover 24. As shown in FIG. 10, the dust collection path 24c may gently curve to a right side and communicate with the cutting dust collection box 25. Because of this configuration, cutting dust flows into the cutting dust collection box 25 through the dust collection path 24c along the rotational flow. In the explanation below, the dust collection opening 24b and the dust collection path 24c respectively refer to those leading toward the cutting dust collection box 25. Cutting dust flowing through the dust collection opening 24b and the dust collection path 24c accumulates within the cutting dust collection box 25. Cutting dust accumulated within the cutting dust collection box 25 can be discharged by removing the cutting dust collection box 25 from the fixing cover 24 and opening the cover 29.

As shown in FIG. 6, in the present embodiment, a guide member 40 is provided at the dust collection opening 24b. The guide member 40 is provided on an upstream end side of a cutting dust collection wall 24d that defines the cutting dust path 24c in the fixing cover 24. The guide member 40 extends downwards from an end of the cutting dust collection wall 24d. As shown in FIG. 8, the guide member 40 has a rectangular plate form. Also, the guide member 40 has a fork shape due to a slit 40a formed by a cut provided from a lower end of the guide member 40. The guide member 40 extends over both sides of the circular saw blade 22, such that the circular saw blade 22 passes through the slit 40a. Cutting dust blown up from the cutting position C may be guided by the guide member 40, thereby improving dust collection efficiency into the cutting dust collection box 25.

According to the tip saw cutter 1 of the present embodiment configured as described above, the distances X1, X2 between the inner wall surface 24a of the fixing cover 24 and the tooth tip 22a may be set longer than the distance T between the tooth tip 22a and the tooth bottom 22b and shorter than twice as long as this distance T (the distance T<the distance X1, X2<the distance T×2). The distances X1, X2 are set within the above ranges in the range of a length from the lower end of the fixing cover 24 to the height H of the rotational center of the circular saw blade 22 (a height of an axis of the output shaft 39 as measured from the upper surface of the base 10). Because the distances X1, X2 are respectively set longer than the distance T, cutting dust stored in the tooth bottom 22b may be smoothly emitted to the space in the area around the distances X1, X2 between the tooth tip 22a and the inner wall surface 24a of the fixing cover 24, thereby improving the dust collection efficiency by the cutting dust collection box 25.

Furthermore, because the distances X1, X2 are set shorter than twice as long as the distance T, the rotational flow of the circular saw blade 22 can fully and influentially act on cutting dust in the space between the tooth tip 22a and the inner wall surface 24a of the fixing cover 24. This allows the cutting dust emitted into the space to be efficiently transferred to the cutting dust collection box 25. In this way, the distances X1, X2 are set such that cutting dust can be emitted from the tooth bottom 22b and the rotational flow can act on cutting dust in a sufficient manner.

Also, because the distance Y between the front end 11a of the window 11 in the base 10 and the tooth tip 22a of the circular saw blade 22 is set longer than the distance T from the tooth bottom 22b to the tooth tip 22a, and shorter than twice as long as the distance T, cutting dust stored in the tooth bottom 22b can be smoothly emitted to the space in the vicinity of the distance Y and collected into the fixing cover 24. Furthermore, because the distance Y is set shorter than twice as long as the distance T, the rotational flow of the circular saw blade 22 can fully act on the emitted cutting dust, thus allowing the cutting dust to be flown into the fixing cover 24 in a reliable manner. In this respect, dust collection efficiency can be more improved.

Furthermore, in the exemplified embodiment, the distance X1 between the tooth tip 22a and the inner wall surface 24a of the fixing cover 24 at the lower end of the fixing cover 24 and the distance X2 at the height H of the rotational center of the circular saw blade 22 (height of the axis of the output shaft 39), relating to a position in the up-to-down direction, may be set longer than the distance T and shorter than twice as long as the distance T. Especially, the distance X2 is set at the height H of the rotational center where a distance between the tooth tip 22a and the inner wall surface 24a of the fixing cover 24 is minimized, thereby improving dust collection efficiency.

Furthermore, the distance X1 is set longer than the distance Y between the front end 11a of the window 11 in the base 10 and the tooth tip 22a of the circular saw blade 22 on an upstream side before the dust collection opening 24b of the cutting dust collection box 25. Because of this configuration, cutting dust can be smoothly emitted from the tooth bottom 22b into the dust collection opening 24b leading to the cutting dust collection box 25, thereby improving dust collection efficiency.

Furthermore, in the exemplified embodiment, the guide member 40 is provided to guide cutting dust on the side of the dust collection opening 24b. Because of the presence of the guide member 40, cutting dust can be efficiently emitted to the dust collection opening 24b.

Furthermore, the guide member 40 is arranged in a tilting manner such that an outside of the guide member 40 in a radial direction of the circular saw blade 22 is displaced toward a front side in a rotational direction of the circular saw blade 22. Also, the guide member 40 has a fork shape extending on both sides, in a thickness direction, of the circular saw blade 22. Because of this configuration, dust collection efficiency through the dust collection opening 24b can be furthermore improved.

Various modifications can be made to the above described embodiment. For example, the distances X1, X2 between the tooth tip 22a and the inner wall surface 24a of the fixing cover 24, or the distance Y between the tooth tip 22a and the front end 11a of the window 11 can be modified within a range longer than the distance T between the tooth tip 22a and the tooth bottom 22b and also shorter than twice as long as the distance T.

In the exemplified embodiment, the distance X1 is set at the lower end of the fixing member 24 and the distance X2 is set at the height H of the rotational center of the circular saw blade 22. However, the distance between the tooth tip 22a and the inner wall surface 24a of the fixing cover 24 may be properly set with respect to the distance T of the circular saw blade, based on a height position of the dust collection opening 24b.

1. A portable circular saw for cutting metal, comprising:
a base with a lower surface which is configured to contact a cutting material including a metal; and
a cutting device main body supported on an upper surface of the base, the cutting device main body comprising:
a circular saw blade;
a fixing cover that covers a portion of an outer circumference of the circular saw blade; and
a cutting dust collection box that collects metal cutting dust generated when the metal is cut, wherein cutting is performed while the circular saw blade protrudes from the lower surface of the base via a window provided in the base and a protruding portion of the circular saw blade cuts into the cutting material, wherein;
X1 is a distance between an inner wall surface of a lower end of the fixing cover and a tooth tip of the circular saw blade,
T is a distance between the tooth tip and a tooth bottom of the circular saw blade, and
T<X1<2T.

2. The portable circular saw according to claim 1, wherein:
Y is a distance between a front end of the window in the base and the tooth tip of the circular saw blade, and
T<Y<2T.

3. The portable circular saw according to claim 1, wherein,
X2 is a distance between the inner wall surface of the fixing cover and the tooth tip of the circular saw blade at a height of a rotational center of the circular saw blade relating to a position in an up-down direction, and
T<X2<2T.

4. The portable circular saw according to claim 2, wherein:
X1>Y.

5. The portable circular saw according to claim 1, wherein:
a dust collection path into the cutting dust collection box is defined and arranged along the outer circumference of the circular saw blade,
a guide member is provided in a dust collection opening located at an inflow side end of the dust collection path, and
the guide member is configured to guide the metal cutting dust into the dust collection opening.

6. The portable circular saw according to claim 5, wherein,
the guide member is arranged such that a portion of an outside of the guide member in a radial direction of the circular saw blade is positioned radially inward of the outer circumference of the circular saw blade, and
the guide member has a fork shape extending on both sides, in a thickness direction, of the circular saw blade.

7. The portable circular saw according to claim 5, wherein:
a first portion of the guide member is arranged adjacent the dust collection opening, and
the first portion of the guide member is positioned radially outward of the outer circumference of the circular saw blade.

8. The portable circular saw according to claim 7, wherein:
a second portion of the guide member is arranged away from the dust collection opening, and
the second portion of the guide member is positioned radially inward of the outer circumference of the circular saw blade.

9. The portable circular saw according to claim 5, wherein:
the guide member includes a fork shaped portion, and
the fork shaped portion of the guide member is located between side walls of the fixing cover in an axial direction of the circular saw blade.

10. A portable circular saw for cutting metal, comprising:
a base with a lower surface which is configured to contact a cutting material including a metal; and
a cutting device main body supported on an upper surface of the base, the cutting device main body comprising:
a circular saw blade;
a fixing cover that covers a portion of an outer circumference of the circular saw blade; and
a cutting dust collection box that collects metal cutting dust generated when the metal is cut, wherein cutting is performed while the circular saw blade protrudes from the lower surface of the base via a window provided in the base and a protruding portion of the circular saw blade cuts into the cutting material, wherein:
a distance between an inner wall surface of the fixing cover and a tooth tip of the circular saw blade is greater than a distance between the tooth tip and a tooth bottom of the circular saw blade, and
the distance between the inner wall surface of the fixing cover and the tooth tip of the circular saw blade is less than twice the distance between the tooth tip and the tooth bottom.

11. The portable circular saw according to claim 10, wherein the inner wall surface of the fixing cover is located radially outward and in from of the outer circumference of the circular saw blade.

12. The portable circular saw according to claim 10, wherein the distance between the inner wall surface of the fixing cover and the tooth tip of the circular saw blade is measured from a portion of the inner wall surface of the fixing cover adjacent the window when the protruding portion of the circular saw blade is at a maximum protruding position.

13. The portable circular saw according to claim 10, wherein the distance between the inner wall surface of the fixing cover and the tooth tip of the circular saw blade is measured from a portion of the inner wall surface of the fixing cover nearest the tooth tip.

14. The portable circular saw according to claim 10, wherein:
a distance between a front end of the window in the base and the tooth tip of the circular saw blade is greater than the distance between the tooth tip and the tooth bottom, and
the distance between the front end of the window in the base and the tooth tip of the circular saw blade is less than the distance between the inner wall surface of the fixing cover and the tooth tip of the circular saw blade.

15. The portable circular saw according to claim 14, wherein the distance between the front end of the window in the base and the tooth tip of the circular saw blade is measured when the protruding portion of the circular saw blade is at a maximum protruding position.

16. The portable circular saw according to claim 10, wherein the distance between the inner wall surface of the fixing cover and the tooth tip of the circular saw blade is greater than, but less than twice, the distance between the tooth tip and the tooth bottom over a length of the inner wall surface of the fixing cover between a portion nearest the base and a portion nearest a rotational center of the circular saw blade.

17. The portable circular saw according to claim 10, wherein:
a dust collection path into the cutting dust collection box is defined and arranged along the outer circumference of the circular saw blade,
a guide member is provided at an inflow side end of the dust collection path, and
the guide member is configured to guide the metal cutting dust into the dust collection opening.

18. The portable circular saw according to claim 17, wherein a distance between an end of the guide member at the inflow side end of the dust collection path and the inner wall surface of the fixing cover is greater than the distance between the tooth tip and the tooth bottom.

19. The portable circular saw according to claim 17, wherein a distance between an end of the guide member positioned away from the inflow side end of the dust collection path and the inner wall surface of the fixing cover is greater the distance between an end of the guide member at the inflow side end of the dust collection path and the inner wall surface of the fixing cover.

20. The portable circular saw according to claim 17, wherein:
the guide member has a fork shape extending on both sides, in a thickness direction, of the circular saw blade.
